(19) United States
(12) Patent Application Publication
(10) Pub. No.: US 2008/0035432 A1
(43) Pub. Date: Feb. 14, 2008

(54) Railway car hand brake lever

(75) Inventors: Michael E. Ring, Saint John, IN (US); Kristofer Heitmeyer, West Linn, OR (US); Jonathon Marlow, Hobart, IN (US); Michael J. Moriarity, Lansing, MI (US)

Correspondence Address: JAMES RAY & ASSOCIATES, 2640 PITCAIRN ROAD, MONROEVILLE, PA, 15146, US

(73) Assignee: WABETC HOLDING CORP.

(21) Appl. No.: 11/891,916

(22) Filed: Aug. 14, 2007

Related U.S. Application Data
(60) Provisional application No. 60/837,528, filed on Aug. 14, 2006.

(51) Int. Cl. B61H 13/02; F16C 1/10

(52) U.S. Cl. 188/52; 74/502.2

(57) ABSTRACT

A hand brake lever for use on a truck mounted type railway car brake system includes a first elongated portion which is horizontally disposed when the hand brake lever is installed in such car brake system and a second elongated portion which is connected to first elongated portion and which is disposed in a generally vertical direction and at a predetermined angle so that a second end of the second elongated portion is spaced at a predetermined distance from such truck bolster when the hand brake lever is installed in such system. A plurality of apertures are formed though the first elongated portion for connecting the hand brake lever to each of a brake actuator, a brake beam, a slack adjuster trigger mechanism, and a slack adjuster mechanism. An aperture is formed through the second elongated portion for connecting hand brake chain thereto.

### CROSS-REFERENCE TO RELATED APPLICATIONS

This application is related to and claims priority from Provisional Patent Application Ser. No. 60/837,528 filed Aug. 14, 2006.

### FIELD OF THE INVENTION

The present invention relates, in general, to hand brakes for use with truck mounted railway car brake systems and, more particularly, this invention relates to a hand brake lever specifically designed to enable pulling the hand brake chain attached to such hand brake lever towards the bolster of the railway car truck as opposed to away from such truck bolster.

### BACKGROUND OF THE INVENTION

Prior to the conception and development of the present invention hand brake levers were designed to move the chain connected to the brake system away from the bolster in order to set the brakes on a car equipped with a truck mounted brake system.

When it became necessary to change the manner and direction in which the hand brake lever moved there were not, to applicants' knowledge, any hand brake lever systems available which could meet this requirement.

Additionally, the hand brake system was still required to meet the minimum brake shoe force mandated for overall safety of such system.

### SUMMARY OF THE INVENTION

The present invention provides a hand brake lever for use with a hand brake connected to a railway car truck mounted brake system which requires moving the chain in a direction towards the truck bolster when setting the hand brake. Such hand brake lever includes a first elongated portion which is generally horizontally disposed when such hand brake lever is installed in the system. Such first elongated portion has each of a first predetermined length, a first predetermined thickness and a first predetermined shape. A predetermined number of apertures are formed though such first elongated portion for enabling connection of the hand brake lever to each of the brake actuator, brake beam, slack adjuster trigger mechanism, and slack adjuster mechanism. The aperture for connecting such slack adjuster mechanism to the first elongated portion of the hand brake lever is disposed adjacent and spaced from a first end of the first elongated portion of the hand brake lever. A second elongated portion is connected at a first end thereof to the first end of the first elongated portion of the hand brake lever and is disposed in a generally vertical direction when such hand brake lever is installed in the system, so that the second end of the second elongated portion is spaced at a predetermined distance from the truck bolster when such hand brake lever is installed in the system. An aperture is provided closely adjacent a second end of the second elongated portion of the hand brake lever to enable connection of the hand brake chain thereto. Such second elongated portion has each of a second predetermined length, a second predetermined thickness and a second predetermined shape.

### OBJECTS OF THE INVENTION

It is, therefore, one of the primary objects of the invention to provide a hand brake lever for use with a hand brake system on a railway car which allows a chain to be pulled toward the truck bolster when setting the hand brake on such car.

Another object of the present invention is to provide a hand brake lever for use with a hand brake system on a railway car which can be formed as a single piece stamping or casting.

A further object of the present invention is to provide a hand brake lever for use with a hand brake system on a railway car which enables the hand brake system to achieve minimum brake force.

In addition to the various objects and advantages of the invention described above, various other objects and advantages of the invention will become more readily apparent to those persons skilled in the relevant art from the following more detailed description of the invention, particularly, when such description is taken in conjunction with the attached drawing figures.

### BRIEF DESCRIPTION OF THE DRAWING

FIG. 1 is a perspective view showing a presently preferred embodiment of the hand brake lever for a railway car hand brake system connected to the railway car brake system and connected to the hand brake chain;

FIG. 2 is a perspective enlarged view showing the hand brake lever illustrated in FIG. 1;

FIG. 3 is a top view of the hand brake lever illustrated in FIGS. 1-2; and

FIG. 4 is a cross-sectional view of the hand brake lever taken along lines 4-4 in FIG. 3.

### BRIEF DESCRIPTION OF A PRESENTLY PREFERRED EMBODIMENT OF THE INVENTION

Prior to proceeding to the more detailed description of the invention it should be noted that, for the sake of clarity and understanding, identical components which have identical functions have been identified with identical reference numerals throughout the several views illustrated in the drawing Figures.

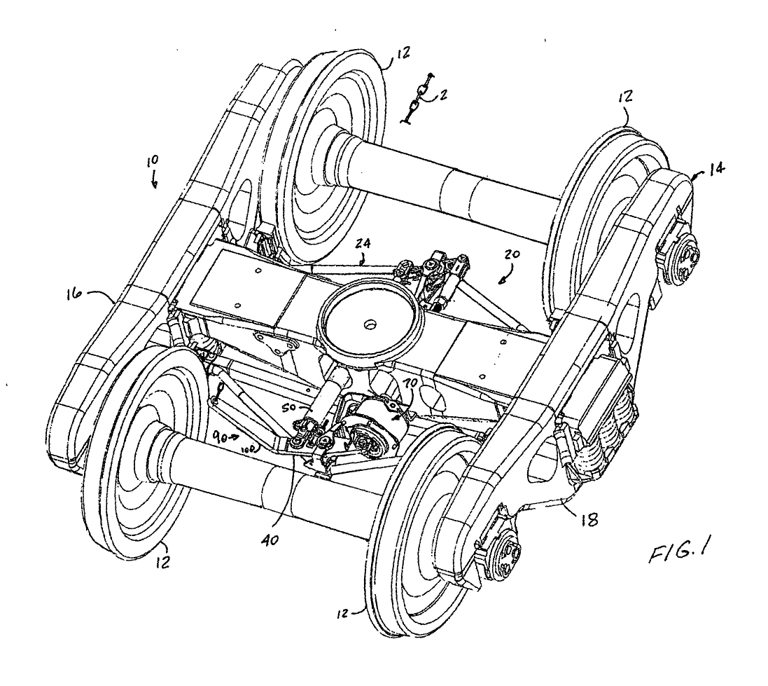

Referring to FIGS. 1-4 of the drawings, there is shown a railway car brake system, generally designated as 20, including a pair of spaced-apart parallel brake beams 22 and 24 that are adapted to be mounted on the truck 10 of a railway car (not shown) by guide feet 26 that are formed on removable brake heads 28 of the respective beams. The brake heads 28 are mounted on the ends of the brake beams 22, 24 and carry brake shoes 30 for engagement with the wheels 12 of the railway car truck 10. Guide channels (not shown) in the side frames 16, 18 of the truck bolster 14 are arranged to receive the brake beam guide feet 26 in a well-known manner in order to support the brake beams 22, 24 and to guide the brake shoes 30 into proper braking engagement with the wheel treads.

Brake beams 22 and 24 may be a conventional, truss design comprising a compression member 32, a tension member 34, and a strut member 36. The compression and tension members 32 and 34 are welded together at their outer extremities to which brake heads 30 are removably-fixed, as by rivets or other suitable fasteners. Strut member 36 is rigidly-connected between the compression and tension members at their midpoints. Being of relatively lightweight construction, such design is well-known to provide a low-cost brake beam capable of supporting high brake forces.

In the preferred construction of brake beams 22 and 24, as employed in the present invention, the brake beams are bent at their midpoint so as to be V-shaped, as disclosed in U.S. Pat. No. 4,830,148, and assigned to the assignee of the present invention. Such an arrangement better accommodates mounting of the brake rigging components without encountering interference with the brake beam members, while at the same time allowing the brake application force to be applied in line with the brake shoe force to avoid brake beam torque.

Pivotally-mounted by a pin 38 on an upraised portion of strut member 36, in the proximity of tension member 34, is an elongated transfer lever 40 associated with brake beam 22. The pin 38 is received within an aperture 39 which is formed through the transfer lever 40 and which is disposed intermediate its outer ends. Similarly, an elongated transfer lever 42 is pivotally-mounted by a pin 44 to an upraised portion of strut member 36 associated with brake beam 24. In mounting these transfer levers 40 and 42 above the tension member 34, the transfer levers 40 and 42 may be located in proximity with the tension member of the respective beams without encountering interference therewith upon rotation of the transfer levers. The aforementioned bent-beam concept allows the transfer levers 40, 42 to be upraised from the beam midpoint, while still maintaining these levers in a plane common to the brake beam ends, at which point the brake shoe force is applied without imparting braking torque to the beam.

Corresponding opposed ends of transfer levers 40 and 42 are interconnected through force-transmitting members 46 and 48.

Force-transmitting member 46 may be a simple connecting rod or, as shown here, a slack adjuster mechanism 50, such as the slack adjuster mechanism disclosed in U.S. Pat. No. 4,662,485, assigned to the assignee of the present invention. The teaching of U.S. Pat. No. 4,662,485 is incorporated into this document by reference thereto. One end 52 of the slack adjuster body is connected to a first end 54 of the transfer lever 40 by a pin 56 received within an aperture 57 formed through such transfer lever 40 and disposed adjacent and spaced from the first end 54, while the opposite end 58, associated with an actuating rod 60 that is axially movable relative to the slack adjuster housing, is connected by a pin 62 in a similar manner to a first end 64 of transfer lever 42. A slack adjuster trigger mechanism 67 is pivotally-mounted to the slack adjuster housing and is connected to the transfer lever 40 by a pin 68 which is received within an aperture 69 formed through such transfer lever 40 and disposed intermediate the apertures 57 and 39.

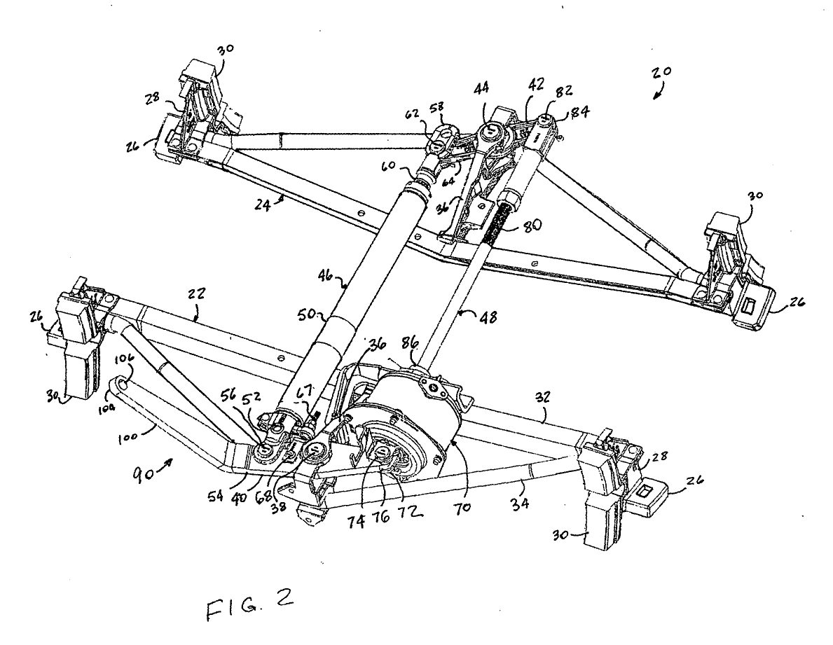

Force-transmitting member 48 includes a pneumatic brake actuator device, such as a conventional, piston-type brake cylinder 70 shown in FIGS. 1-2 or an expansible air bag actuator disclosed in U.S. Utility patent application Ser. No. 10/645,035 filed on Aug. 21, 2003. This application is assigned to the assignee of the present invention and its teaching is incorporated into this document by reference thereto.

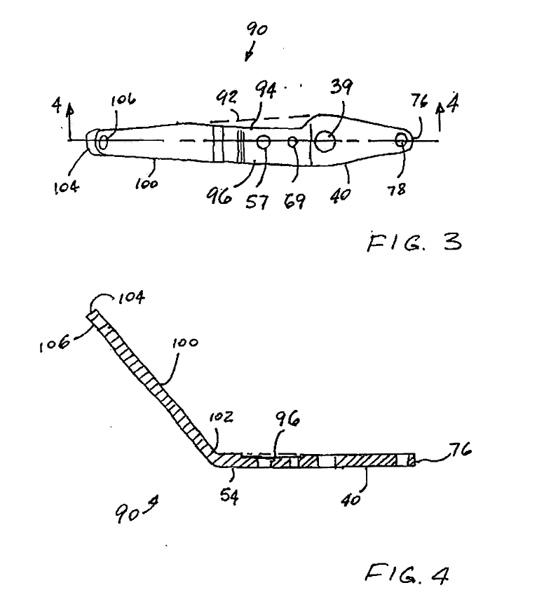

Brake cylinder 70 is suitably mounted to the brake beam 22 by being bolted or otherwise fixed to the beam compression member 32, at a location on one side of strut member 36 between compression member 32 and tension member 34. Alternatively, brake cylinder 70 may be carried by the brake system 20 without mounting directly to the brake beam, particularly where a lightweight-type brake cylinder, such as the expansible air bag, is employed. With either mounting arrangement, a piston push rod 72 is connected by a pin 74 to a second end 76 of the transfer lever 40. The pin 74 is received within an aperture 78 which is formed through the transfer lever 40. As best shown in FIG. 3, the aperture 78 which enables connecting such brake actuator 70 to the transfer lever 40 is disposed closely adjacent and spaced from the second end 78 of the transfer lever 40.

One end of a connecting rod 80 is connected by a pin 82 to a second end 84 of transfer lever 44. The other end of the connecting rod 80 is pinned to a lug 86 of the brake cylinder 70. This swivel connection accommodates relative vertical and lateral movement of the respective brake beams and associated links without binding at the brake cylinder-connecting rod joint.

Cooperatively arranged with the above-described brake system 20 is a hand brake lever, generally designated as 90, which is connected to the chain 2 and which moves such chain 2 in a direction towards the truck bolster 14 when setting the hand brake (not shown) which is conventionally mounted at one end of the railway car (not shown).

The reader's attention is now directed to FIGS. 3-4. Illustrated therein is the hand brake lever 90 constructed according to a presently preferred embodiment of the invention. Such hand brake lever 90 integrally incorporates the force transfer lever 40 described in details above which is generally horizontally disposed when such hand brake lever 90 is installed in the brake system 20. Accordingly, the transfer lever 40 is hereinafter referred to as a first elongated portion 40 of the hand brake lever 90. The first elongated portion 40 has each of a first predetermined length, a first predetermined thickness and a first predetermined shape. Briefly, the plurality of apertures 39, 57, 72 and 78 are formed though such first elongated portion 40 for enabling connection of the hand brake lever 90 to each of the brake beam 22, the slack adjuster mechanism 50, the brake actuator 70, and the slack adjuster trigger mechanism 68 respectively. In order to achieve movement of the hand brake lever 90 in a direction towards the truck bolster 14 when setting the hand brake (not shown), the aperture 57 which enables connecting such slack adjuster mechanism 50 to the first elongated portion 40 of the hand brake lever 90 is disposed adjacent and spaced from the first end 54 of the first elongated portion 40 of the hand brake lever 90. The aperture 78 which enables connecting such brake actuator 70 to the first elongated portion 40 of the hand brake lever 90 is disposed closely adjacent the second end 76 of the first elongated portion 40 of the hand brake lever 90. The aperture 39 which enables connecting such brake beam 22 to the first elongated portion 40 of the hand brake lever 90 is disposed intermediate each end of the first elongated portion 40 of the hand brake lever 90 and adjacent the aperture 78 for connecting such brake actuator 70 to the first elongated portion 40 of the hand brake lever 90. Finally, the aperture 69 which enables connecting such slack adjuster trigger mechanism 67 to the first elongated portion 40 of the hand brake lever 90 is disposed intermediate the aperture 57 which enables connecting such slack adjuster mechanism 50 and the aperture 39 which enables connecting such brake beam 22 to the first elongated portion 40 of the hand brake lever 90.

In a particular reference to FIG. 3, a portion 94 of a truck bolster facing edge 92 of the first elongated portion 40 of the hand brake lever 90 tapers at a predetermined angle in a direction towards a longitudinal axis of the first elongated portion 40 of the hand brake lever 40. The tapered portion 94 starts adjacent the first end 54 of the first elongated portion 40 and ends between the aperture 69 which enables connecting such slack adjuster trigger mechanism 67 to the first elongated portion 40 of the hand brake lever 90 and the aperture 39 which enables connecting such brake beam 22 to the first elongated portion 40. It has been found that the tapered edge portion 94 is required for positioning the slack adjuster mechanism 50 to the left of the brake actuator 70, as best shown in FIGS. 1-2 and for providing operable clearances in a horizontal plane with at least one of a bifurcated end 52 of such slack adjuster mechanism 50 and a bifurcated end member of such slack adjuster trigger mechanism 67.

Now in a particular reference to FIG. 4, there is illustrated a recess 96 which is formed in a top surface of the first elongated portion 40 and which is disposed intermediate the aperture 39 which enables connecting such brake beam 22 to the first elongated portion 40 and the first end 54 of the first elongated portion 40 of the hand brake lever 90. The recess 96 reduces the first predetermined thickness of the first elongated portion 40 of the hand brake lever 90. It has been found that in order to consistently achieve required brake shoe force without fatiguing the hand brake lever 90, the first predetermined thickness of the first elongated portion 40 should be about 1.0 inch. This presented a problem in connecting slack adjuster mechanism 50 since a conventional opening in a bifurcated end 52 of the slack adjuster mechanism 50 is configured for a mating with a conventional 0.75 thick transfer lever and is formed between about 0.813 inches and about 0.873 inches. It has been further found that such conventional thickness of about 0.75 inches employed with conventional transfer levers resulted in greater than desirable twisting of the slack adjuster mechanism 50 due to mating clearances between the first elongated portion 40 and the bifurcated end 52. Similar fit problem was experienced in connecting the slack adjuster trigger mechanism 67 to the first elongated portion 40 having thickness of about 1.0 thick. Accordingly, it has been found necessary to form a recess 96 in the portion of the first elongated portion 40 to between about 0.795 inches and about 0.805 inches in order to provide for a predetermined fit of the first elongated portion 40 of the hand brake lever 90 within a bifurcated end 52 and, more particularly, to reduce twisting of the slack adjuster mechanism 50 and eliminate fatiguing of the hand brake lever 90 during continuous use. Thus, the aperture 57 which enables connecting such slack adjuster mechanism 50 to the first elongated portion 40 of the hand brake lever 90 and the aperture 69 which enables connecting such slack adjuster trigger mechanism 67 to the first elongated portion 40 of the hand brake lever 90 are formed through the reduced thickness of the first elongated portion 40 of the hand brake lever 90.

In further reference to FIGS. 1-4, there is illustrated a second elongated portion 100 which is connected at a first end 102 thereof to the first end 54 of the first elongated portion 40 of the hand brake lever 90. The second elongated portion 100 is disposed in a generally vertical direction and at a predetermined angle so that a second end 104 of the second elongated portion 100 is spaced at a predetermined distance from such truck bolster 14 when the hand brake lever 90 is installed in such brake system 20. The second elongated portion 100 has each of a second predetermined length, a second predetermined thickness and a second predetermined shape. An aperture 106 is formed through the second elongated portion 100 closely adjacent the second end 104 thereof to enable connection of such hand brake chain 2 to the hand brake lever 90, as best shown in FIG. 1. In operation to set the hand brake (not shown), the second elongated portion 100 moves toward the truck bolster 14 carrying a distal end of the hand brake chain 2 therewith. The presently preferred second predetermined thickness of the second elongated portion 100 is about 1.0 inch being identical to the first predetermined thickness of the first elongated portion 40.

Although the second elongated portion may be welded to the first elongated portion, the hand brake lever 90 is preferably manufactured as a single piece construction by a stamping or a casting method from AISI 4140 steel plate and heat treated to between about 33 RC and about 39 RC.

As was demonstrated during a conventional brake shoe test on a 70 ton truck, the hand brake lever 90 constructed according to the embodiments of the present invention generated required brake shoe force of about 28,000 pounds with a 3,000 pound input from the hand brake.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

We claim:

1. A hand brake lever for use on a truck mounted type railway car brake system which requires moving a distal end of a hand brake chain in a direction towards a truck bolster when setting such hand brake, said hand brake lever comprising:
(a) a first elongated portion which is generally horizontally disposed when said hand brake lever is installed in such car brake system, said first elongated portion having each of a first predetermined length, a first predetermined thickness and a first predetermined shape;
(b) a predetermined plurality of apertures which are formed though said first elongated portion for enabling connection of said hand brake lever to each of a brake actuator, a brake beam, a slack adjuster trigger mechanism, and a slack adjuster mechanism, said aperture which enables connecting such slack adjuster mechanism to said first elongated portion of said hand brake lever is disposed adjacent and spaced from a first end of said first elongated portion of said hand brake lever;
(c) a second elongated portion which is connected at a first end thereof to said first end of said first elongated portion of said hand brake lever and which is disposed in a generally vertical direction and at a predetermined angle so that a second end of said second elongated portion is spaced at a predetermined distance from such truck bolster when said hand brake lever is installed in such system, said second elongated portion has each of a second predetermined length, a second predetermined thickness and a second predetermined shape; and
(d) an aperture which is formed through said second elongated portion closely adjacent said second end of said second elongated portion of said hand brake lever to enable connection of such distal end of such hand brake chain thereto.

2. The hand brake lever, according to claim 1, wherein said aperture which enables connecting such brake actuator to said first elongated portion of said hand brake lever is disposed closely adjacent a second end of said first elongated portion of said hand brake lever.

3. The hand brake lever, according to claim 2, wherein said aperture which enables connecting such brake beam to said first elongated portion of said hand brake lever is disposed intermediate each end of said first elongated portion of said hand brake lever and adjacent said aperture for connecting such brake actuator to said first elongated portion of said hand brake lever.

4. The hand brake lever, according to claim 3, wherein said aperture which enables connecting such slack adjuster trigger mechanism to said first elongated portion of said hand brake lever is disposed intermediate said aperture which enables connecting such slack adjuster mechanism and said aperture which enables connecting such brake beam to said first elongated portion of said hand brake lever.

5. The hand brake lever, according to claim 1, wherein said first elongated portion of said hand brake lever includes a recess which is formed in a top surface thereof and which is disposed intermediate said aperture which enables connecting such brake beam to said first elongated portion and said first end of said first elongated portion of said hand brake lever, said recess forming a reduced thickness portion of said first elongated portion of said hand brake lever.

6. The hand brake lever, according to claim 5, wherein said aperture which enables connecting such slack adjuster mechanism to said first elongated portion of said hand brake lever and said aperture which enables connecting such slack adjuster trigger mechanism to said first elongated portion of said hand brake lever are formed through said reduced thickness portion of said first elongated portion of said hand brake lever.

7. The hand brake lever, according to claim 5, wherein said reduced thickness of said first elongated portion of said hand brake lever provides for a predetermined fit of said first elongated portion of said hand brake lever within a bifurcated end member of such slack adjuster mechanism.

8. The hand brake lever, according to claim 1, wherein a portion of a truck bolster facing edge of said first elongated portion of said hand brake lever tapers at a predetermined angle in a direction towards a longitudinal axis of said first elongated portion of said hand brake lever, said tapered edge portion starts at about a connection of said first end of said second elongated portion and said first end of said first elongated portion and ends between said aperture which enables connecting such slack adjuster trigger mechanism to said first elongated portion of said hand brake lever and said aperture which enables connecting such brake beam, said tapered edge portion providing operable clearance in a horizontal plane with at least one of a bifurcated end member of such slack adjuster mechanism and a bifurcated end member of such slack adjuster trigger mechanism.

9. In combination with a hand brake system for a railway vehicle including a pair of spaced-apart brake beams mounted at each end of said car mounted brake system, each of said brake beams having a brake head attachable to each end thereof, each of said brake heads carrying a brake shoe thereon, each of said brake heads being positioned for engagement of a respective one of said brake shoes with a respective railway vehicle wheel during a brake application, each of said brake beams having a transfer lever pivotally connected at a point intermediate the ends thereof, a first force transmitting member attached to opposed first ends of each of said transfer levers and a second force transmitting member attached to opposed second ends of said each of said transfer levers, said second force-transmitting means including brake actuator means operable in response to the supply of fluid pressure thereto for increasing the length of said second force-transmitting member, to accordingly increase the spaced-apart distance between said pair of brake beams for applying said brake shoes, the improvement comprising:
(a) a hand brake lever which is secured at a first end thereof to a first end of a first transfer lever and which is disposed in a generally vertical direction and at a predetermined angle so that a second end of said hand brake lever is spaced at a predetermined distance from a truck bolster when said brake system is installed in said truck bolster, said second end of said hand brake lever is movable in a direction towards said truck bolster when setting the hand brake, said hand brake lever having each of a predetermined length, a predetermined thickness and a predetermined shape;
(b) a recess which is formed in a top surface of said first transfer lever and which forms a reduced thickness portion thereof for cooperatively mating with at least a connected end of said first force transmitting member; and
(c) a taper which is formed in a truck bolster facing edge of said first transfer lever and which tapers at a predetermined angle in a direction towards a longitudinal axis of said first transfer lever, said tapered edge starts from about a connection of said first end of said hand brake lever and said first end of said first transfer lever and ends between said aperture which enables connecting such slack adjuster trigger mechanism to said first transfer lever and said aperture which enables connecting such brake beam to said first transfer lever, said tapered edge portion providing operable clearance in a horizontal plane with at least a connected end of said first force transmitting member.

10. The hand brake system, according to claim 9, wherein said reduced thickness portion of said first transfer lever is between about 0.795 inches and about 0.805 inches.

11. A brake system mounted on a truck bolster of a railway car, said brake system comprising:
(a) first and second spaced-apart brake beams, each of said brake beams having a brake head attachable to each end thereof, each of said brake heads carrying a brake shoe thereon, each of said brake heads being positioned for engagement of a respective one of said brake shoes with a respective railway vehicle wheel during a brake application;
(b) a first transfer lever having a first elongated portion thereof pivotally connected to a first brake beam at a point intermediate the ends thereof, said first elongated portion is generally horizontally disposed when said hand brake lever is installed in said brake system, and a second elongated portion which is connected at a first end thereof to a first end of said first elongated portion of said first transfer lever and which is disposed in a generally vertical direction and at a predetermined angle so that a second end of said second elongated portion is spaced at a predetermined distance from such truck bolster when said first transfer lever is installed in said brake system, said second elongated portion having an aperture which is formed therethrough closely adjacent said second end of said second elongated portion of said first transfer lever to enable connection of a hand brake chain thereto, whereby said second elongated portion and such hand brake chain are movable in a direction towards such truck bolster when setting such hand brake;
(c) a second transfer lever pivotally connected to a second brake beam at a point intermediate the ends thereof;
(d) a first force transmitting member attached to opposed first ends of each of said first and second transfer levers; and
(e) a second force transmitting member attached to opposed second ends of said first and second transfer levers, said second force-transmitting means including brake actuator means operable in response to the supply of fluid pressure thereto for increasing the length of said second force-transmitting member, to accordingly increase the spaced-apart distance between said pair of brake beams for applying said brake shoes.

12. The brake system, according to claim 11, wherein said first force transmitting member includes a slack adjuster mechanism which has one end thereof connected to said first elongated portion of said first transfer lever adjacent and spaced from said first end thereof.

13. The brake system, according to claim 12, wherein said first force transmitting member further includes a slack adjuster trigger mechanism which is operably connected to said slack adjuster mechanism adjacent said one end thereof and which has one end thereof connected to said first elongated portion of said first transfer lever between a connection of said one end of said slack adjuster mechanism and a second end of said first elongated portion.

14. The brake system, according to claim 11, wherein said brake system includes a predetermined plurality of apertures which are formed though said first elongated portion for enabling connection of said first transfer lever to each of said first brake beam, said first force transmitting member, and said second force transmitting member.
